(19) United States
(12) Patent Application Publication
(10) Pub. No.: US 2009/0009466 A1
(43) Pub. Date: Jan. 8, 2009

(54) Force-sensing orthotic electric device controller

(76) Inventors: Sandra L. Hubbard, Ft. White, FL (US); Michael Rosen, Burlington, VT (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/113,543

(22) Filed: May 1, 2008

Related U.S. Application Data
(60) Provisional application No. 60/915,165, filed on May 1, 2007.

(51) Int. Cl. G09G 5/00

(52) U.S. Cl. 345/156

(57) ABSTRACT

The invention is directed to devices and methods for assisting individuals with poor extremity function (i.e., upper extremity function) to control devices. In one embodiment, a powered device is provided that comprises a controller and an orthosis communicably connected to the controller. An orthosis includes a harness worn by a user on a body part and a force sensing transducer positioned between the harness and the body part, wherein force applied to the transducer by the body part is communicated to the controller for controlling movement of the powered device. A method for controlling a device having a controller includes attaching a harness to a user's body part and applying a force by the body part onto a force sensing transducer positioned between the harness and the body part, wherein the force is communicated to the controller for controlling the device.

### CROSS-REFERENCE TO RELATED APPLICATION

The present application claims the benefit of U.S. Provisional Application Ser. No. 60/915,165, filed May 1, 2007, which is hereby incorporated by reference herein in its entirety, including any figures and drawings.

### BACKGROUND OF THE INVENTION

Individuals with severe motor impairment of the upper quadrants are limited in their use of technology (i.e., power wheelchairs, computers and alternative and augmentative communication devices). Existing methods of accessing mobility or communication devices require either head stability (e.g., to use a head pointer) or upper extremity (UE) control (i.e., to use a joystick). Individuals with severe motor impairment of the upper quadrants frequently have neither head stability nor functional UE use. Thus, standard interface methods are inapplicable to this population (i.e., individuals with tetraplegia due to diagnoses such as cerebral palsy, Frederick's Ataxia, etc.).

Accordingly, a need exists for a mechanism by which users having little or no extremity function or head stability are able to control powered devices.

### BRIEF SUMMARY

The subject invention addresses many of the above-noted problems with the current disability devices. The subject invention comprises a controller and an interface communicably connected to the controller, where the interface is to be worn over a user's body part. The controller operates a powered device according to instructions provided by the user via the interface.

In a preferred embodiment the orthosis includes a harness worn by a user on a foot and a force sensing transducer positioned between the harness and various parts of the foot, wherein force applied to the transducer by various parts of the foot (i.e., toes) is communicated to the controller for controlling movement of the computer mouse.

In another embodiment, the powered device is wheelchair and the interface is an orthosis. The orthosis includes a harness worn by a user on a foot and a force sensing transducer positioned between the harness and various parts of the foot, wherein force applied to the transducer by various parts of the foot (i.e., toes) is communicated to the controller for controlling movement of the wheelchair.

In another embodiment, an orthosis is provided for controlling a device other than a wheelchair. A method for controlling a device having a controller includes attaching a harness to a user's body part and applying a force by the body part onto a force sensing transducer positioned between the harness and the body part, wherein the force is communicated to the controller for controlling the device. In one embodiment, the powered device is computer mouse and the interface is an orthosis.

### BRIEF DESCRIPTION OF THE DRAWINGS

FIG. 1 is a side view of an exemplary embodiment of an orthosis of the present disclosure.

FIG. 2 is a photograph of a side view of an exemplary embodiment of an orthosis of the present disclosure.

FIG. 3 is a photograph of a front view of an exemplary embodiment of two orthoses of the present disclosure, one for each of a user's feet.

FIG. 4 is log-log plot of force (g) vs. resistance (kΩ) of a Force Sensing Resistor (FSR).

FIG. 5 is a photograph of an exemplary embodiment of a square FSR.

FIG. 6 shows an exemplary circuit design.

### DETAILED DISCLOSURE

The subject invention provides systems and methods for assisting individuals with poor extremity function and/or head stability to control and use devices. The subject invention comprises a controller and an interface communicably connected to the controller, where the interface is worn over, or attached to, a body part of the user. The controller operates a powered device according to instructions provided by the user via the interface. In one embodiment, the interface comprises control sensors mounted on an orthosis worn on an adjacent proximal limb segment (e.g., the foot, where control inputs are produced by the toes).

A device of the subject invention is any powered, assistive device that provides mobility, communication, entertainment, health and/or hygiene to improve quality of everyday life for physically challenged individuals. Examples of devices of the invention include, but are not limited to, mobility devices (e.g., wheelchairs, scooters, etc.), communication devices (e.g., telephones, cell phones, etc.), dressing aids, entertainment (i.e., book holders, Television or radio controllers, and page turners), computer products (e.g., a computer mouse, a computer keyboard, etc.), and the like.

### Interface

According to the subject invention, the point of control over the device is provided by an interface located on the user's body as opposed to an interface positioned on the device (i.e., a joystick mounted on or near an arm rest). With conventional devices controlled by interfaces located on the device itself, extraneous, inadvertent movements from the user often cause the device to function in a manner not desired by the user. By providing the point of control over a device on the user's body, the effect of extraneous movements is reduced. For example, involuntary and extraneous movements associated with voluntary reaching and postural maintenance against gravity in individuals with abnormal muscle tone (i.e., athetoid, dystonic, ataxic) are eliminated by providing the point of control on a user's body. Activation of the controller over a device is less distorted by unintended motor output.

Controlled midline movement is required to operate most conventional devices (i.e., a wheelchair, where the upper extremity must remain on an armrest of the wheelchair). In certain individuals, controlled movement in the vicinity of the midline is especially difficult. For example, individuals with neuromotor disorder are dominated by involuntary movement and primitive reflexes such at the reflexes (ATNR). Because the interface of the subject invention is worn on a user's body part, the need to maintain limb position at or near body midline is eliminated.

According to the subject invention, it is feasible for the disclosed body-referenced orthotic control interface to be activated across, for example, any joint in the body; that is, between any two articulated body segments. Thus, in certain embodiments, the interface can comprise an orthosis with sensors on any wearable device, such as a glove, shoe insole, or other piece of apparel. In one embodiment, the interface can comprise an orthosis with sensors on a decorative glove, shoe, boot, or other piece of apparel.

Because the interface is placed on the user's body, the user's voluntary muscle force (i.e., from a digit) can be exerted against a sensor of the interface that is stabilized by (i.e., referenced to) an adjacent more proximal segment of the same limb. Such a mounting scheme is beneficial, especially if the limb is subjected to a perturbation, because both the control digit and the stabilizing surface will be displaced together with relatively little change in the distance or force between them.

In one embodiment, the interface of the invention requires fewer anticipatory postural reactions of the trunk and less coordination to operate the device than normally required with conventional devices. In a related embodiment, user operation of a device is based on fewer forces (i.e., ligamentous, frictional, etc.) than those associated with actually moving a limb. For example, a traditional joystick requires the user to overcome abnormal movement patterns just to access the joystick. Further control over abnormal motor patterns is then required to exert accurate dynamic control over the joystick, seriously challenging the user's capacities. According to this embodiment, the limb used to operate the interface can be in a position assumed by the user or placed in a posture effective in reducing involuntary motor activity.

In another embodiment, the interface has the ability to sense isometric force. In a related embodiment, the interface comprises an orthosis worn over the body part of the user, where at least one strain sensitive transducer is mounted to the surface of the orthosis. Activation forces (i.e., instructions for the controller) are applied by the body part while stabilization forces are provided by the orthosis.

Flexion and Extension (FE) of the toes, relative to the foot, is natural and requires little concentration. Application of FE force, i.e., force up and down (dorsal and plantar), with little or no motion is also an undemanding motor act. In one embodiment of the invention, the interface comprises a miniature force-sensing joystick mounted in and under a foot orthosis and operated by the user's toes. An isometric joystick configured to embrace (for example, fit between and wrap partially around) the big and first toes is used in a related embodiment to produce one channel of control. Such an interface senses flexion and extension forces of the toes and torsion produced by relative rotation of the toes, where such movement by the user communicates various commands of operation to control the device.

In another embodiment, the interface communicates with a controller on a wheelchair to navigate the wheelchair. In a related embodiment, the wheelchair is controlled by proportional isometric force. The interface comprises strain-sensitive transducers mounted to an orthosis; output signals from the transducers/orthosis communicate with the controller. In certain related embodiments, the orthosis communicates with the wheelchair power-control electronics via wireless technology.

An advantage of the use of approximately isometric force rather than movement or positional control is that if the two articulated body segments are submitted to external contract forces or to inertial forces, such as from wheelchair accelerations, for example, both the control limb segment and the reference limb segment will be displaced together with relatively little change in the force between them. Thus, it is expected that such external forces will not inadvertently cause erroneous control inputs. In other embodiments, other types of forces may be employed. Moreover, while wheelchair control is exemplified in the present disclosure, the technology can also be generalized to computer and alternative augmentative communication (AAC) access and control, for example.

### Controller

The controller is responsive to output signals communicated from the interface. The overall goal of the controller is to operate a device in accordance with signals communicated from the user via the interface.

In one embodiment, the controller is a microprocessor that is electrically coupled to a device. The microprocessor may be analog or digital and should contain circuits to be programmed for performing device operational functions based on various signals communicated from an interface. Circuits or programs for performing such operational functions are conventional and well known. In addition, while the controller has been described as having a single microprocessor for operating a device, it should be understood that two or more microprocessors could be used.

In certain embodiments, the controller may continually monitor the signals provided by the interface. In other embodiments, communications from the interface can be stored in the memory of a microprocessor for as-needed retrieval and analysis. The memory may be, for example, a floppy disk drive or internal RAM or hard drive of the associated microprocessor. Data can be stored by the microprocessor to provide a permanent log of all events related to the user's instructions via the interface to operate the device.

In a related embodiment, the controller is a microprocessor that is electrically coupled to a wheelchair. The controller includes circuits or programs for performing such operational functions as speed and direction of the wheelchair. The circuits or programs for performing such operational functions are conventional and well known.

### Wheelchair Application

Wheelchair steering is a two-degree-of-freedom control task, including control of fore-aft motion and left-right (turning) motion or equivalently, speed and direction. Scissoring of the first toe up and big toe down, as if to cross the former over the latter, is medial relative rotation (MRR) in the sense that the upper toe begins to cross medially over the big toe. The opposite is also straightforward: relative rotation of the big toe upward and across the first toe is lateral movement of the upper toe: lateral relative rotation (LRR). As for FE, production of force, with little or no rotation, while a less common activity, is also feasible.

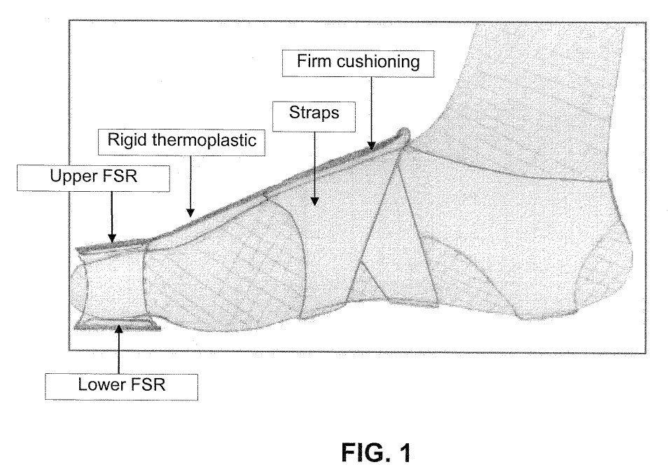

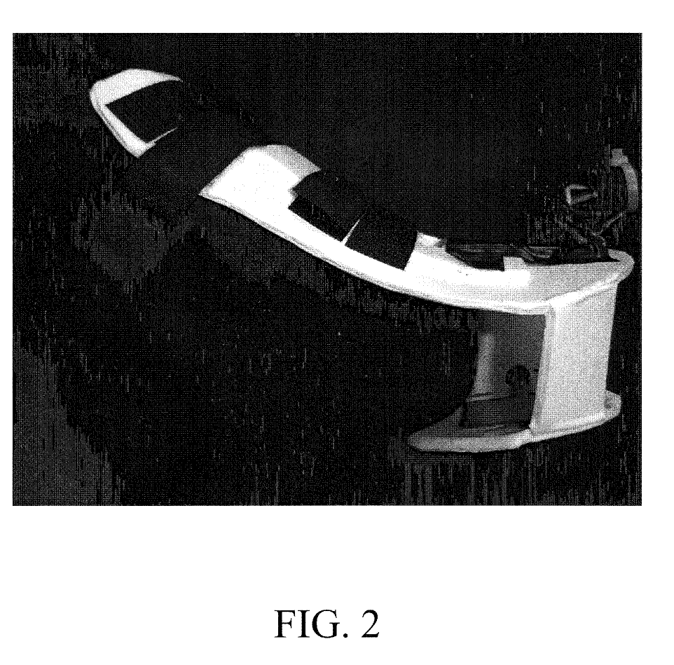

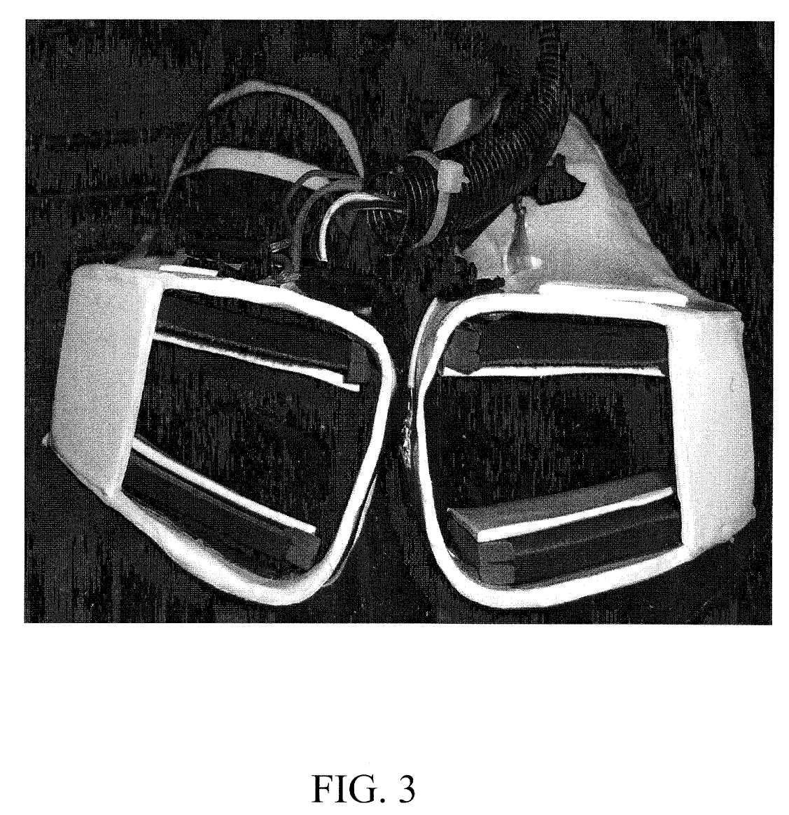

An embodiment of the pressure-, strain- or force-sensing orthotic electric power wheelchair (EPW) controller of the present disclosure uses two square-shaped Force Sensing Resistors (FSRs) and an orthoplast on each of the user's feet. In a related embodiment, the output signals of the force-sensitive transducers communicate with the wheelchair power control, providing two-degree-of-freedom control of the EPW in speed and direction. As shown in FIGS. 1, 2 and 3, there are two FSR's per foot: an upper FSR above the toes and a lower FSR beneath the toes. In an exemplary embodiment, the upper FSRs serve to activate the electronically controlled wheelchair (ECW) to move in the reverse direction. The lower FSRs serve to activate the ECW to move in the forward direction. A “skid steer” control model is used in which each foot will independently control one motor. In an exemplary embodiment, the left foot controls the right side motor, and the right foot controls the left side motor. This allows for intuitive steering in either direction. The user determines the speed of the wheelchair by applying varying amounts of pressure to the FSRs with his/her toes. To turn the wheelchair, the user applies more pressure to one foot than the other.

In another embodiment, direction control is accomplished by dorsiflexion and plantarflexion the primary foot while speed control is accomplished by dorsiflexion and plantarflexion the secondary foot. A sensor alternative uses distributed strain sensing. In this embodiment, for example, the outside dorsal and/or plantar surface of the orthosis on each foot is instrumented with a bridge circuit of suitably placed strain gauges. Linearized by downstream processing, the magnitude and sign of the signal from these sensors is used to control direction or speed. Such a design takes advantage of the orthosis shell itself as a mechanical element of the sensor system. A challenge with this approach is standardizing the placement of strain gauges on off-the-shelf orthoses while tolerating thermoforming for custom fitting for an individual user.

In one embodiment, the user wears a force-sensing orthosis such as a foot harness. Thus, the wheelchair control system is referenced the user's body rather than to the wheelchair frame. By moving the point of access, or reference frame, of the control from the wheelchair frame to the user's body, extraneous movements associated with reaching and postural maintenance against gravity are reduced. This is especially beneficial for individuals with abnormal muscle tone (i.e., athetoid, dystonic, ataxic). A wearable interface eliminates the need for a user to repeatedly reposition a limb to grasp or contact an externally mounted control. Activation forces are supplied by the body part while stabilization forces are provided by the orthosis.

In a related embodiment, interface signaling is based on ankle extension/flexion and/or inversion eversion torques, where the shank is the frame of reference. The mechanical combination of one of these torques with toe extension/flexion force relative to the foot (or the application of the two torques about the ankle alone) are sensed and decoupled by suitably placed strain gauges mounted to the outside surface of an orthosis. Such embodiments take advantage of the orthosis shell itself as a mechanical element whose strain can be sensed.

In yet another embodiment, a single foot is used to control both direction and speed. This design would be suitable for users who have only unilateral motor control, for example. One implementation makes use of unison and differential action of the big toe and the four small toes (FST) used together. Unison dorsiflexion or plantarflexion force of the big toe and FST results in forward or reverse motion, respectively, of the EPW along a straight path. Relative force, i.e. the difference between the forces applied by the big toe and the FST controls steering. This design may be accomplished by mounting four FSRs on a single orthosis: one above and one below the big toe and one above and one below the FSTs acting together.

According to yet another embodiment of the invention, the orthosis is designed to provide sufficient space for the toes or other contemplated body part for comfort and operation. In a related embodiment, padding consists of a thermoplastic or rubber bridge across foam, formed to the top of the user's body part (i.e., foot). In yet another embodiment, hook and loop fastener (e.g., VELCRO®) straps secure the orthosis to the foot or other body part.

An orthoplast material can be used to create the orthosis. A suitable material is a low-temperature thermoplastic with excellent drape, moldability and rigidity, available under the name ORTHOPLAST® II from Medco School First Aid, Tonawanda, N.Y. The orthoplast can be custom fit to the foot or other body part of the user. Where the orthosis is for the foot, it can be worn over a standard sock and have the ability to fit inside a standard sneaker or shoe or be concealed by an age- and occasion-appropriate orthotic cover. In this embodiment, the orthosis provides a rigid surface against which pressure can be applied to the FSR through forces produced by the toes. This provides a platform that is not referenced to the wheelchair, but rather to the user's foot. Between the FSRs and the toes, there may be cushioning foam to reduce the pressure felt by the FSRs in order to maximize the range of force the user will be able to apply.

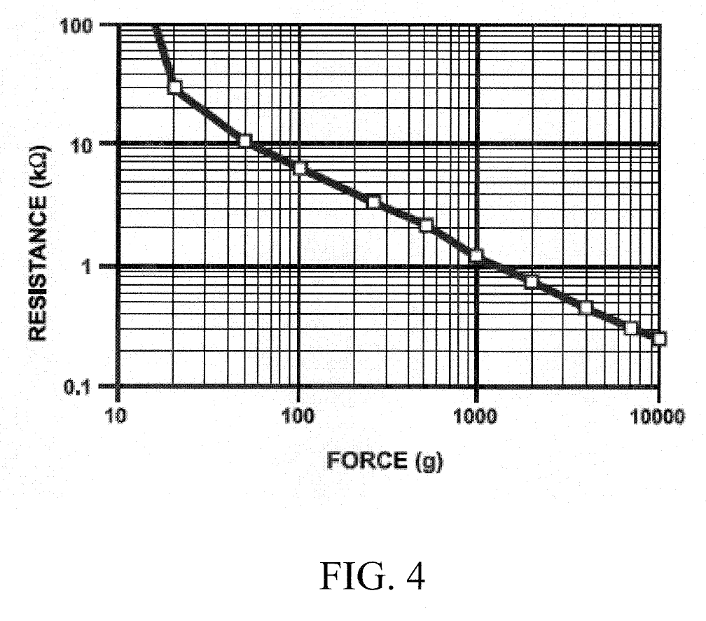

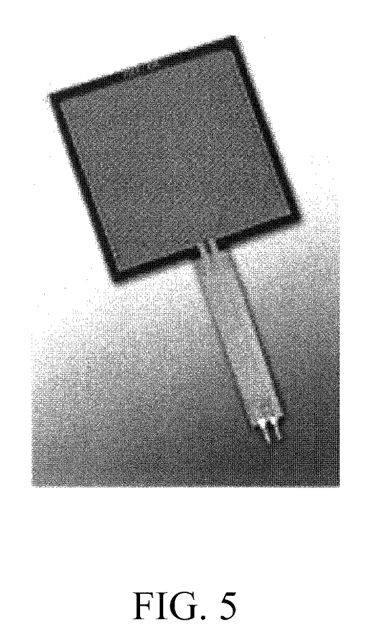

When no force is applied, the FSR acts as an infinite resistor. As more force is applied, the resistance drops in a manner that is inversely proportional to the force. A log-log plot of force vs. resistance can be seen in FIG. 4. Small square-shaped FSRs are particularly suitable because they can be used in the confined spaces of a foot harness and do not need to be mounted to a surface on the wheelchair. A suitable FSR is available as model FSR460 from Interlink Electronics, Camarillo, Calif. The square FSR shown in FIG. 5 is 1.5 inches on each side. It has a force sensitivity range of 1-100 N and a pressure sensitivity range of 1.5-150 psi. As specified above, a cushioning foam can be used to limit the amount of force felt by the FSR. This allows for an effective force range that is much larger than specified by the manufacturer. In an exemplary embodiment, the FSRs ar-e provided in a sealed transducer array that can be mounted on an orthosis shell and then removed and reused when the orthosis needs replacement.

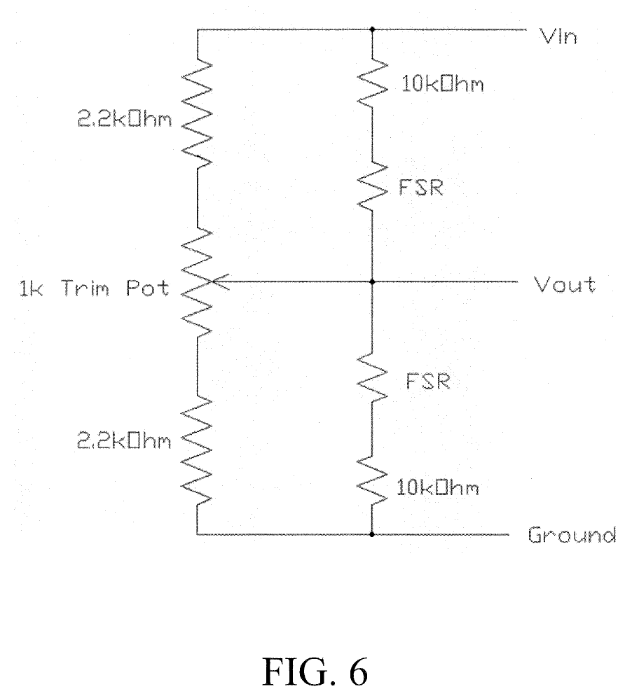

In order to effectively implement the FSRs into an ECW control system, a circuit is designed in conjunction with proper signal processing to allow for desired wheelchair performance. The aim is to have acceleration and steering characteristics that mimic current ECW hand controls. FIG. 6 shows an exemplary circuit design, in which a trim pot is introduced to adjust neutral voltage (6.02V are used to start the wheelchair). In an exemplary embodiment, the user interface and wheelchair are connected via cable through an easily disconnected jack and plug. Circuitry can also be designed to allow for a wireless orthosis.

Though application of the subject invention to a wheelchair has been described in detail, embodiments of the present invention can be used with any powered, assistive device that provides mobility, communication, entertainment, health and/or hygiene to improve quality of everyday life for physically challenged individuals. Examples of devices of the invention include, but are not limited to, mobility devices (e.g., scooters, etc.), communication devices (e.g., telephones, cell phones, etc.), dressing aids, entertainment (e.g., book holders, television and radio controllers, and page turners), computer products (e.g., a computer mouse, a computer keyboard, etc.), and the like. In one embodiment, a device of the present invention can be any powered, assistive device that is not a wheelchair.

It should be understood that the examples and embodiments described herein are for illustrative purposes only and that various modifications or changes in light thereof will be suggested to persons skilled in the art and are to be included within the spirit and purview of this application.

We claim:

1. A device, comprising:
a controller;
an orthosis communicably connected to the controller, the orthosis comprising:
a harness worn by a user on a body part; and
a force sensing transducer positioned between the harness and the body part, wherein a force applied to the transducer by the body part is communicated to the controller for controlling movement of the device.

2. The device of claim 1, wherein the device is a computer mouse.

3. The device of claim 2, wherein the body part is a foot.

4. The device of claim 1, wherein the orthosis is connected to the controller via a cable.

5. The device of claim 1, wherein the orthosis is connected to the controller wirelessly.

6. The device of claim 1, further comprising a cushion positioned between the force sensing transducer and the body part.

7. The orthosis of claim 1, wherein the body part is a foot.

8. The orthosis of claim 1, wherein the force is a pressure force.

9. An orthosis for controlling a device comprising a controller, the orthosis comprising:
a harness worn by a user on a body part; and
a force sensing transducer positioned between the harness and the body part, wherein a force applied to the transducer by the body part is communicated to the controller for controlling the device.

10. The orthosis of claim 9, wherein the device is a computer mouse.

11. The orthosis of claim 10, wherein the body part is a foot.

12. The orthosis of claim 9, wherein the force is a pressure force.

13. The orthosis of claim 9, wherein the body part is a foot.

14. The orthosis of claim 13, further comprising:
a first force sensing transducer positioned above a toe; and
a second force sensing transducer positioned below a toe.

15. The orthosis of claim 14, further comprising:
a third force sensing transducer positioned above a plurality of toes; and
a fourth force sensing transducer positioned below a plurality of toes.

16. The orthosis of claim 9, further comprising a cushion positioned between the force sensing transducer and the body part.

17. A method for controlling a device comprising a controller, the method comprising:
attaching a harness to a user's body part; and
applying a force by the body part onto a force sensing transducer positioned between the harness and the body part, wherein the force is communicated to the controller for controlling the device.

18. The method of claim 17, wherein the device is a computer mouse.

19. The method of claim 18, wherein the user's body part is a foot.

20. The method of claim 19, further comprising:
applying a first force by a first toe onto a first force sensing transducer; and
applying a second force by a second toe onto a second force sensing transducer;
wherein application of the first force and the second force result in different movements of the computer mouse.
